(19) United States
(12) Patent Application Publication
(10) Pub. No.: US 2013/0198243 A1
(43) Pub. Date: Aug. 1, 2013

(54) SYSTEM AND METHOD FOR DYNAMICALLY GENERATING A GUI ACCORDING TO TABLE RELATIONSHIPS IN A DATABASE

(71) Applicant: Brien Robert Givens, Barrie (CA)

(72) Inventor: Brien Robert Givens, Barrie (CA)

(21) Appl. No.: 13/637,810

(22) PCT Filed: Mar. 29, 2011
(86) PCT No.: PCT/CA11/50164

§ 371 Date: Nov. 29, 2012

Related U.S. Application Data
(60) Provisional application No. 61/318,453, filed on Mar. 29, 2010.

(51) Int. Cl. G06F 17/30

(52) U.S. Cl. CPC G06F 17/30595
USPC 707/805

(57) ABSTRACT

A system and method used to create a graphical user interface to a relational database, wherein the method for creating the graphical user interface (GUI) to a relational database, comprises: specifying a relationship between at least two tables (210): dynamically generating the GUI by creating layers of page frames according to the specified relationships (220): and displaying the GUI (230).

### RELATED APPLICATIONS

This application claims priority from U.S. Provisional Application No. 61/318,453 filed Mar. 29, 2010, which is hereby incorporated by reference in its entirety.

### FIELD

Embodiments described herein relate to systems and methods for providing and creating a graphical user interface (GUI) to a relational database.

### BACKGROUND

In relational database theory, a relationship between two tables is created by including a column (field) within the “child” table to store the primary key (or other candidate key) of its “parent” table. This column is referred to as the foreign key of the parent table. In each row, the stored value of the primary key is referred to as the primary id of the row and the stored values of any foreign keys are the row's foreign ids.

### SUMMARY

In a first aspect, a method is provided to create a graphical user interface to a relational database as a database interface system.

In another aspect, a computer implemented method for creating a graphical user interface (GUI) to a relational database is provided. The method comprising: specifying a relationship between at least two tables; dynamically generating the GUI by creating layers of page frames according to the specified relationships; and displaying the GUI.

In a preferred case, the GUI is organized into page frames comprising levels of structural blocks.

In another case, the GUI comprises a browser based interface.

In another case, the database tables and fields are created or updated (modifying the table or field name, field data type, nullability and/or addition/removal of indexes) for the graphical user interface when a database is rebuilt by or through the embodiments as described in more detail herein.

In another case, audit columns are automatically added to corresponding tables in the graphical user interface when a database is rebuilt by or through the embodiments as described in more detail herein.

In another aspect, a non-transitory machine-readable memory is provided. In various embodiments the non-transitory machine-readable memory stores statements and instructions for execution by a processor for performing any of the methods described herein.

In another aspect, a system is provided to create a graphical user interface to a relational database as a database interface system.

In another aspect, a system for creating a graphical user interface (GUI) to a relational database is provided. The system comprises: a display; and a processor configured to: specify a relationship between at least two tables; and dynamically generate the GUI by creating layers of page frames according to the specified relationships; and display the GUI on the display.

In a preferred case, the system further comprising an input device, wherein the relationships between the at least two tables are specified based on input provided to the input device.

In another case, the display and the processor are distributed in an n-tier architecture.

In another case, the GUI is organized into page frames comprising levels of structural blocks.

In another case, the GUI comprises a browser based interface.

In another case, the database tables and fields are created or updated (modifying the table or field name, field data type, nullability and/or addition/removal of indexes) for the GUI when a database is rebuilt by or through the embodiments as described in detail below.

In another case, audit columns are automatically added to corresponding tables in the GUI when the relational database is rebuilt by or through the embodiments described in detail below.

In another aspect, a programming language is provided to create a graphical user interface to a relational database as a database interface system.

### BRIEF DESCRIPTION OF DRAWINGS

Embodiments will now be described, by way of example only, with reference to the attached Figures, wherein:

FIG. 1 illustrates a block diagram of a GUI creation system according to an embodiment;

FIG. 2 shows a chart with sixteen types of theoretical relationships in a relational database according to an embodiment;

FIG. 3 shows a page selection section controlling 30 pages of data according to an embodiment;

FIG. 4 shows a page selector fly-out according to an embodiment;

FIG. 5 shows a page frame according to an embodiment;

FIG. 6 shows the page frame of FIG. 5 with the first row selected according to an embodiment;

FIG. 7 shows the page frame of FIG. 5 where the first row is edited according to an embodiment;

FIG. 8 shows a table with a drilldown row according to an embodiment;

FIG. 9 shows a table with two S1 child tables in display mode according to an embodiment;

FIG. 10 shows a table with two S1 child tables in edit mode according to an embodiment;

FIG. 11 shows an S4 relationship according to an embodiment;

FIG. 12 shows three states of an M-Table filter button according to an embodiment;

FIG. 13 shows an M-Table filter button's right-click menu according to an embodiment;

FIG. 14 shows the states of an M-Table status indicator according to an embodiment;

FIG. 15 shows an M1 relationship according to an embodiment;

FIG. 16 shows a field validation message according to an embodiment;

FIG. 17 shows a field verification message according to an embodiment;

FIG. 18 shows a delete verification message according to an embodiment;

FIG. 19 illustrates a property inheritance model according to an embodiment;

FIG. 20 illustrates an example of a reference display GUI according to an embodiment;

FIG. 21 illustrates an example of a reference edit GUI according to an embodiment;

FIG. 22 illustrates an example of the reference popup window according to an embodiment;

FIG. 23 illustrates an example of a change format button;

FIG. 24 illustrates an example of an edit button;

FIG. 25 illustrates an example of a show/hide record toggle button; and

FIG. 26 illustrates a flow chart diagram of the basic operational method executed by the system of FIG. 1.

### DETAILED DESCRIPTION

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or a combination of hardware and software. Some embodiments can be implemented in software. Some embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, a smartphone, and a cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. In various embodiments the computer readable medium is a physical computer readable medium. In some embodiments the computer readable medium is a non-transitory computer readable medium. In some embodiments, the medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Some embodiments described herein relate to systems and methods for providing and creating a graphical user interface (GUI) to a relational database. Some embodiments described herein relate to a programming language that is used to create a graphical user interface (GUI) to a relational database. In particular, the programming language introduces concepts of the relational interface and the relational interface development language.

In a relational interface, the organization of the graphical user interface (GUI) reflects the established relationships within the database. A relational interface development language is a programming language that enables the programmer to create a relational interface.

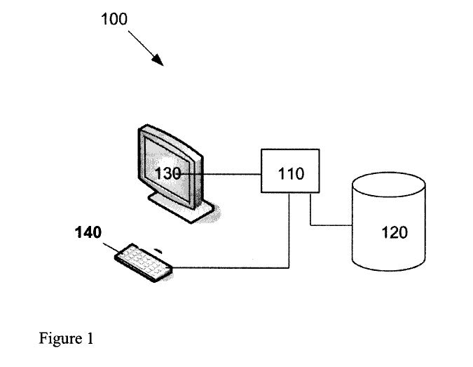

Some embodiments relate to a system for creating a GUI to a relational database. An example embodiment is illustrated in FIG. 1, which is a block diagram of GUI creation system 100. GUI creation system 100 comprises a processor 110, a storage medium 120, an output device 130 and an input device 140. In various embodiments, storage medium 120 is a non-transitory storage medium. In various embodiments storage medium 120 is utilized to store data for use in a relational database as described in greater detail below. Output device 130 can be any appropriate output device such as for example, but not limited to, an LCD monitor. Input device 140 can be any appropriate user input device such as for example, but not limited to, a key board. Some embodiments utilize devices that combine input and output functions such as a touch screen. Processor 110 is utilized to execute computer executable instructions, which may be for example stored on storage medium 120, for the creation of a GUI that is displayed on output device 130. In some embodiments, the instructions executed by processor 110 can be stored on a storage medium other than storage medium 120.

It should be understood that in various embodiments system 100 is not implemented as a single computing device. In particular, in various embodiments, the elements of system 100 are distributed in a multi-tier (or n-tier) architecture. Accordingly, monitor 130 and input device 140 may be part of computing device that interacts in a client server manner with on more computing devices that include processor 110 and storage medium 120.

As shown in FIG. 2, there are 16 different types of relationships which can be established between tables (entities). Various embodiments described herein support all relationship types in which the child table has only one parent table. In the case of a child table with multiple parent tables, various embodiments described herein support the three relationship types which do not specify a minimum number of child records for each unique combination of parent records.

Relationship types S2, S4, S6, S7 and S8 are supported by ensuring that new parent records are not created without also creating the specified minimum number of required child records.

In order to support relationship types M2, M4, M6, M7 and M8, any new record created in parent table A would require a new child record (X new child records for cases M7 and M8) in table C for every existing record in parent table B. All the new required C records would have to be created before the new A record could be saved. These theoretical relationships are not practical and therefore not supported in some of the embodiments that are described herein.

Relationship Types:

### (a) Single-Parent Relationships

The child table in an S1-S8 relation has a single parent table.

### (i) S1

Each record in the parent table has 0 or 1 record in the child table.
Tables with this type of relationship can be used to create optional groups of data within records.

### (ii) S2

Each parent record has 1 record in the child table.
Tables with this type of relationship can be used to create physically separate groups of data within records.
(iii) S3
Each parent record has 0 or more records in the child table.

### (iv) S4

Each parent record has 1 or more records in the child table.

### (v) S5

Each parent record has between 0 and Y records in the child table, where Y>1.

### (vi) S6

Each parent record has between 1 and Y records in the child table, where Y>1.
(vii) S7
Each parent record has between X and Y records in the child table, where X>1 and Y>=X.
(viii) S8
Each parent record has X or more records in the child table, where X>1.

### (b) Multiple-Parent Relationships

The child table in an M1-M8 relationship has two or more parent tables.

### (i) M1

Each unique combination of parent records has 0 or 1 records in the child table.

### (ii) M2

Each unique combination of parent records has 1 record in the child table. This type of relationship is not supported in various embodiments.
(iii) M3
Each unique combination of parent records has 0 or more records in the child table.

### (iv) M4

Each unique combination of parent records has 1 or more records in the child table. This type of relationship is not supported in various embodiments.

### (v) M5

Each unique combination of parent records has between 0 and Y records in the child table, where Y>1.

### (vi) M6

Each unique combination of parent records has between 1 and Y records in the child table, where Y>1. This type of relationship is not supported in various embodiments.
(vii) M7
Each unique combination of parent records has between X and Y records in the child table, where X>1 and Y>=X. This type of relationship is not supported in various embodiments.
(viii) M8
Each unique combination of parent records has X or more records in the child table, where X>1. This type of relationship is not supported in various embodiments.

Nomenclature:

For the purposes of this application, an S1 table is defined as the child table of an S1 relationship, etc. An S1 row or record is defined as the row in the child table where the foreign id matches the primary id of the row in the parent table, etc. A Foreign table is any parent table of a relationship. A table's relational tree refers to the collection of tables including the table itself and all its ancestor tables (all parent tables and their parent tables, etc.). A table's relational parents are all the tables in its relational tree except for the table itself.

GUI Organization:

The GUI described herein is organized into levels of structural blocks called page frames. The tables included in the topmost page frame are either (1) all of the tables in the application, (2) only those tables which do not have parent tables, (3) all the tables from option (2) plus a manual selection of tables, or (4) a manual selection of tables. Tables in subsequent page frames are dependent on the tables of the previous levels.

Page Frames:

A page frame consists of several distinct sections.

Table Selection Section:

The table selection section is the part of the page frame interface that enables the user to select one table from amongst a list of tables. Various embodiments described herein implement this section as a group of tabs which look similar to the tabs on a file folder. This section could also be implemented as a group of radio buttons, a select list (drop-down list) or any other type of pick-one list. Each tab or item in the list displays the table's caption and represents a page of the page frame. Each page has its own Table Data and Page Selection section. Clicking or otherwise selecting a tab (item) in the group (list) switches the display of the Table Data and Page Selection section to that of the selected page. The active page of the page frame is the currently selected page.

Toolbar Section:

This section provides access to the high-level functions of the GUI. Each tool consists of a clickable icon (which could also be a button) and optional tooltip text. The tools provide access to essential functions of the GUI such as Create New Record, Copy Existing Record, Save Changes, Cancel Changes and Delete Selected Record. Edit Selected Record could also be included here; in various embodiments described herein the selected record is edited by simply clicking on it. Each tool functions within the context of the active page. The toolbar can also provide access to other important but less-essential functions of the interface. Many of the functions exposed on the toolbar have keyboard shortcuts, for example Ctrl+S is a shortcut to Save Changes.

Table Data Section:

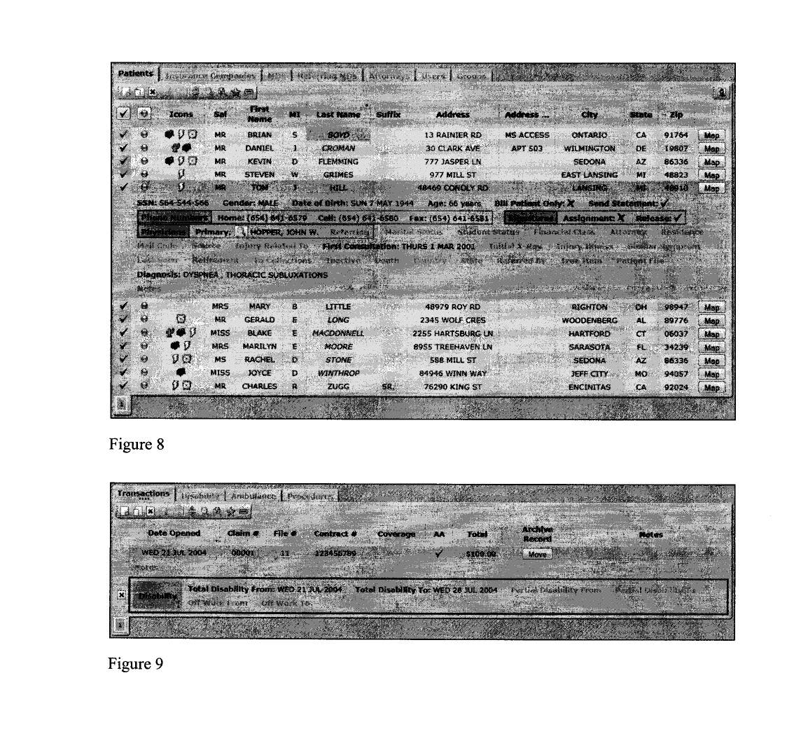

This section provides access to the data of one or more tables in the database. The criteria used to determine which tables are included in a particular page will be discussed later. Each page has one primary table which consists of required inline fields and optional drilldown fields. The data of the inline fields of the page's primary table are displayed in a grid of inline rows and columns in the order in which the developer added them to the interface. The field caption is displayed above each inline column in the grid. Clicking on the inline field caption sorts the data by that column in ascending order; clicking the column again will resort the data in descending order. If the main table has any drilldown fields, they are displayed in a separate drilldown row which is only displayed for the selected record, pinned records and for any records which are in edit mode. In contrast to the grid format of the inline row, the fields of the drilldown row float within the row container. The fields float from the top-left of the container in the order in which the developer added them to the interface. A record's drilldown row appears immediately below its inline row. The fields of any supplemental tables (S1, S2, M1 or Foreign tables) are always drilldown fields and each supplemental table has its own drilldown row which is only displayed for the selected primary table record, pinned records and for any records of the supplemental table which are in edit mode. A table with a drilldown row is shown in FIG. 8. Unlike the primary table drilldown rows, the table caption of the supplemental table appears to the left side of its drilldown rows. In the display mode of the drilldown row the field caption of each field is displayed in bold text to the left of the field value. If the field value is empty then its caption is displayed in a light grey font colour.

The inline rows are alternately highlighted in translucent yellow and translucent white. Clicking on an inline row selects the row and displays any associated drilldown rows for the record. The selected row (including any drilldown rows) is highlighted in translucent red. Clicking on a selected row or pressing the Enter key will switch the record from display mode to edit mode. In display mode none of the row data can be modified. In edit mode each field has its own control for modifying its data. There are several different field types the developer may choose from when developing their application and the edit controls for each field type are specific to the type of data it stores. The properties and functions of each of these field types are beyond the scope of this document.

Pinned Records:

A row of the data table is pinned by selecting the record and then clicking on the Pin Record toolbar button. The drilldown rows of a pinned record stay in place when the selected record changes. The row colouring of a pinned record (including any drilldown rows) follows the alternating translucent yellow/translucent white scheme. A record is unpinned by selecting it and then clicking on the Unpin Record toolbar button. All the pinned records in a data table can be unpinned simultaneously by right-clicking the Pin Record/Unpin Record toolbar button and selecting Unpin All Records from the context-sensitive menu.

Page Selection Section:

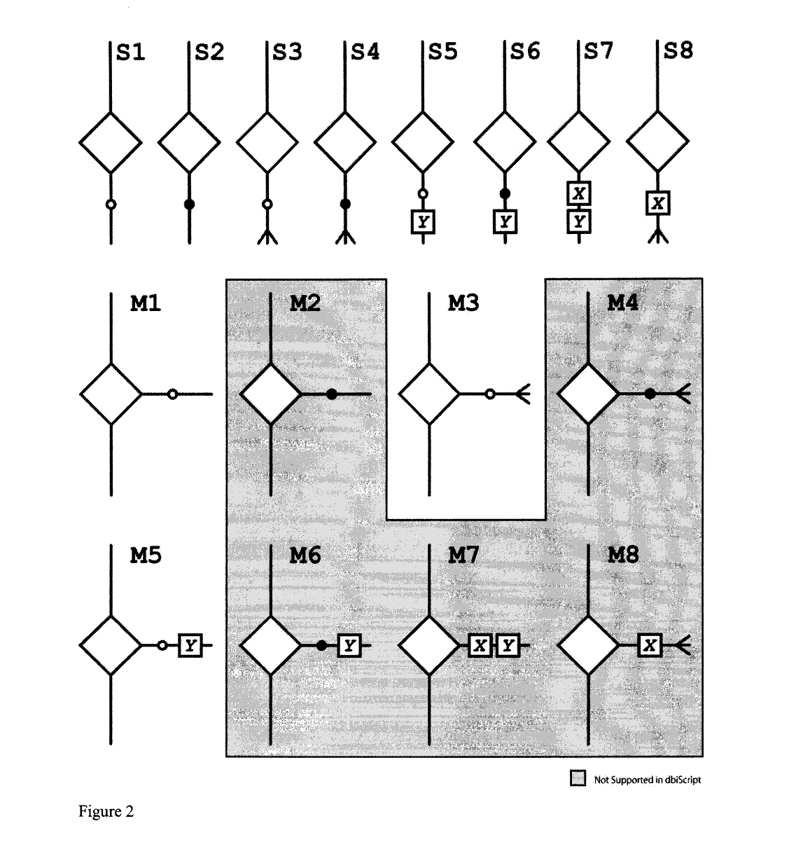

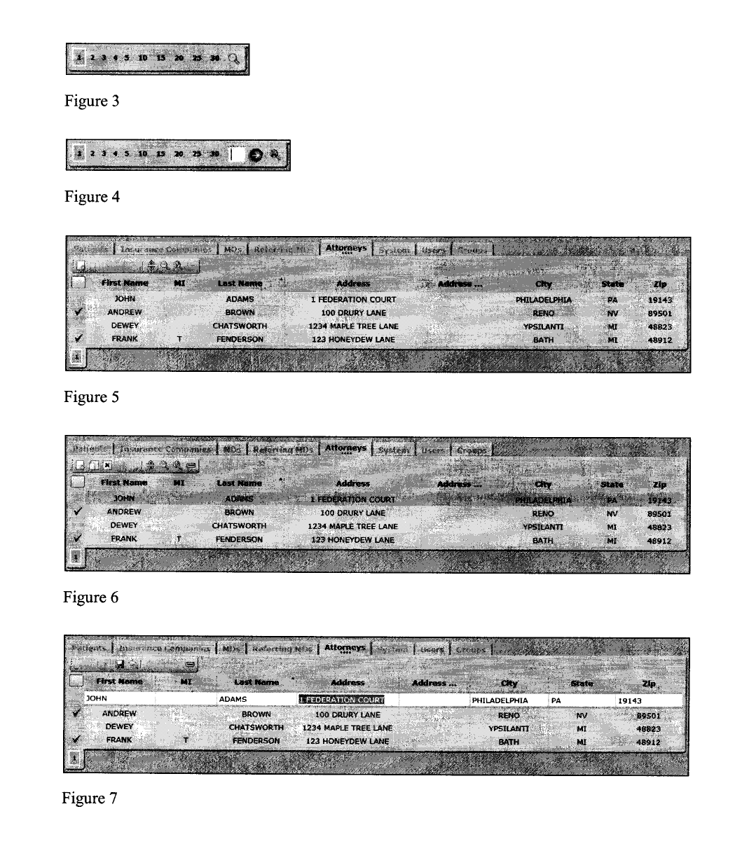

The number of rows displayed in the table section is a property the developer can modify. The default is 15 rows which will be used for this discussion. The data is sorted by the field(s) the developer specifies or which the user selects. The number of rows available in the dataset is affected by any filters the developer or user may have defined. The first page displays the first 15 results; the second page displays results 16-30 and so on. The last page of data may display less than 15 rows. As shown in FIG. 3, the page selection section displays one or more page selectors (clickable numbers) which represent pages in the dataset. Clicking on the page selector retrieves and displays the specified page of data and also highlights the text of the page selector. Clicking on the current (highlighted) page selector will requery the page data and refresh the page. In large data sets a method is used to reduce the number of pages displayed in the page selector. Whenever this paring method is implemented a page selector fly-out is displayed. When clicked, the page selector fly-out displays a textbox with which the user can enter a specific page to display, as shown in FIG. 4.

Page Frame Participation:

A page frame is shown in FIG. 5. FIG. 6 shows the page frame of FIG. 5 with the first row selected. FIG. 7 shows the page frame of FIG. 5 with the first row selected for editing. The placement of a table within the GUI is dependent upon the type of relationship established with its parent(s) as defined in FIG. 2. The developer can choose to include in the topmost page frame (1) all of the tables in the application, (2) only those tables which do not have parent tables, (3) all the tables from option (2) plus a manual selection of tables, or (4) a manual selection of tables. The end-user may also have the ability to change (add or remove from the developers selection) which tables are included in the topmost page frame. Each tab (page) of a page frame has its own child page frame; the child page frame is only displayed when a record is selected in the parent tab's primary table. Since only one tab of a page frame can be active at any time, only the active tab's child page frame will ever be displayed in the child page frame level. In various embodiments described herein, the child page frame is always displayed immediately beneath the parent page frame. The child page frame could also be displayed above the parent page frame or to the left or right of it. In any scenario, the child page frame is only displayed when a record has been selected from the main table of its parent tab in the parent page frame. The tables included in the child page frame are determined by a method which examines the relationships defined between the application's tables. If the method does not identify any tables for participation in the tab's child page frame then the child page frame is never displayed. The records displayed for the data tables of each page are retrieved by dynamically generated SQL statements which are constrained by the foreign ids established through the relationships involving the parent page frame(s).

Filtered Tables:

The developer may choose to filter any table out of the application. A table may be filtered (1) to test alternate configurations, (2) because the user is not permitted to view the table or (3) for any other reason. There may also be tables in the database which the developer can choose not to include in the application. The application will render the interface as if the filtered tables did not exist.

Page Frame Participation Method:

The page frame participation method determines which tables to include in a child page frame based on the tables of a parent tab.

Committed Tables:

The committed tables are a list of every participating table in all the parent tabs.

Uncommitted Relational Parents:

A table's uncommitted relational parents are a list of all its relational parents which are not already committed.

Primary Tables:

Every primary table in the page frame will have its own page in the page frame. The method examines the relational tree of every uncommitted table in the application. To participate in the page frame, at least one of the table's relational parents must participate in the parent page. If the table's relational parents participate in more than one parent page, they must be consecutive pages starting from the immediate parent page and working up to the active page of the topmost page frame. All the uncommitted relational parents of each participating table will also participate as a primary table in the page frame.

Filtering S1, S2 & M1 Tables:

The developer can choose to omit from primary table page frame participation (1) all S1 and S2 tables, (2) all M1 tables, (3) all S1, S2 and M1 tables, (4) any of (1), (2) or (3) plus a manual selection of S1, S2 or M1 tables or (5) a manual selection of S1, S2 or M1 tables. Filtering an S1/S2/M1 table from primary table page frame participation will neither affect its participation as a supplemental table of any page nor will it prevent the page frame participation of any of its uncommitted parents, although any of the uncommitted parents may also be filtered out if they themselves are an S1, S2 or M1 table which matches the filter criteria. The end-user may also have the ability to change (add or remove from the developers selection) which S1/S2/M1 tables are filtered from primary table page frame participation.

Supplemental Tables:

Each page of the page frame is now examined for more tables to participate in the page.

Foreign Tables:

All of the primary table's uncommitted relational parents will participate as a foreign table of the page.

S1, S2 & M1 Tables:

The method examines the relational tree of every uncommitted S1, S2 and M1 table in the application. If all of the S1/S2/M1 table's parent tables are committed or participate in the page then the relationship's child table will also participate in the page. The page participation used for this part of the method is dynamic. Initially it includes the primary table and all foreign tables. Each S1, S2 and M1 table that is identified for participation in the page is added to the list before examining the next table's relational tree. The tables are examined in the order in which the developer added them to the application. Since the application will not allow a developer to add a child table before its parent table(s) have been added, the method is ensured of pulling into the page participation any S1, S2 or M1 tables that are themselves a child of another S1, S2 or M1 table.

Alternate Implementation:

The supplemental tables could each be rendered as a primary table in the child page frame of their primary table's tab. Including them within their primary table's page has the advantage of being more user-friendly.

The GUI

S1 & S2 Tables:

The child record of an S1 or S2 relationship is displayed immediately beneath its parent record. The S1/S2 row only appears when its parent row is selected or is in edit mode. If more than one S1 or S2 relationship exists, the records are displayed in the order the developer added the tables to the application. If a child record does not exist in the database then no row is displayed in display mode. S1/S2 rows are edited in conjunction with their parent row and are always displayed in edit mode. In display mode, an S1 row can be deleted by clicking on the delete icon to the left of the S1 row. In edit mode, any changes to the row can be cleared by clicking on the cancel changes icon which takes the place of the display mode delete icon. The S1 edit row will still be displayed after clicking the cancel changes icon. Since an S2 row is required, no delete or cancel icons are displayed for it.

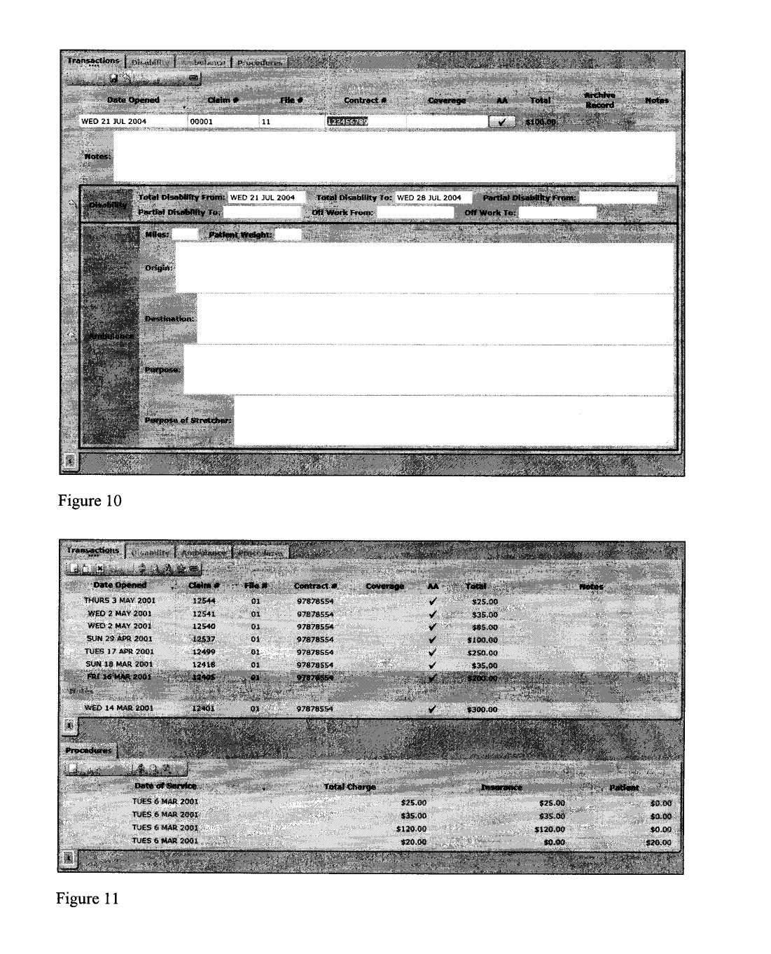

In FIG. 9, the Transactions table has two child S1 tables, Disability and Ambulance. The selected Transaction record does not have a child record in the Ambulance table, so no row appears for the Ambulance table in the display mode of the row. When the Transaction row is switched to edit mode, (by clicking on any field of the Transaction row or the Disability row), the Ambulance row is displayed, as shown in FIG. 10.

S3-S8 Tables:

Each participating S3-S8 table will have its own tab of which it is the primary table. FIG. 11 shows an example of an S4 relationship.

M1 & Foreign Tables:

The GUI representation of M1 and Foreign tables is similar to that of S1 and S2 tables but unlike the S1 and S2 rows, the M1 and Foreign rows can be edited and deleted independently of their primary row. The Foreign tables will have fields that are defined as inline (when the table is accessed as the primary table of a page) but these inline fields will appear as drilldown fields in the Foreign row. In display mode, an M1 or Foreign row can be deleted by clicking on the delete icon to the left of the row. In edit mode, the cancel changes icon takes the place of the display mode delete icon. Clicking on the cancel changes icon will discard any changes made to the row data and switch the row to display mode. Deleting a Foreign row will also delete its primary row and any other primary row on the page that is a child of that Foreign row.

M-Table Filter Button:

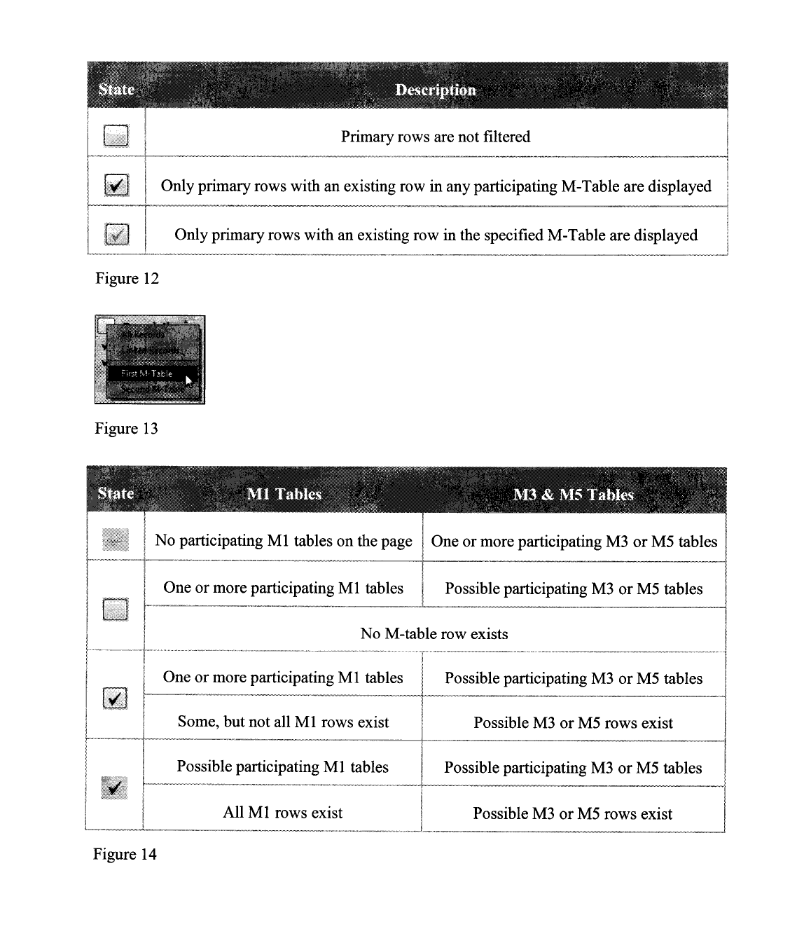

When one or more M tables have a relational parent participating in the page, the leftmost column of the data grid's header row displays an M-Table filter button. The states and meanings of the M-Table filter button are illustrated and explained in FIG. 12.

When the M-Table filter button controls the filtering of two or more M-Tables, a right-click menu becomes available on the M-Table filter button. FIG. 13 shows an example of an M-Table filter button's right-click menu. Selecting a table from the right-click menu will display only those primary rows with an existing row in the participating relational parent table of the selected M-Table and the M-Table filter button then displays a gray checkmark.

M-Table Status Indicator:

An M-Table status indicator appears in the leftmost column of each primary row when one or more M-Tables have a relational parent participating in the page. The states and meanings of the M-Table status indicator are explained FIG. 14.

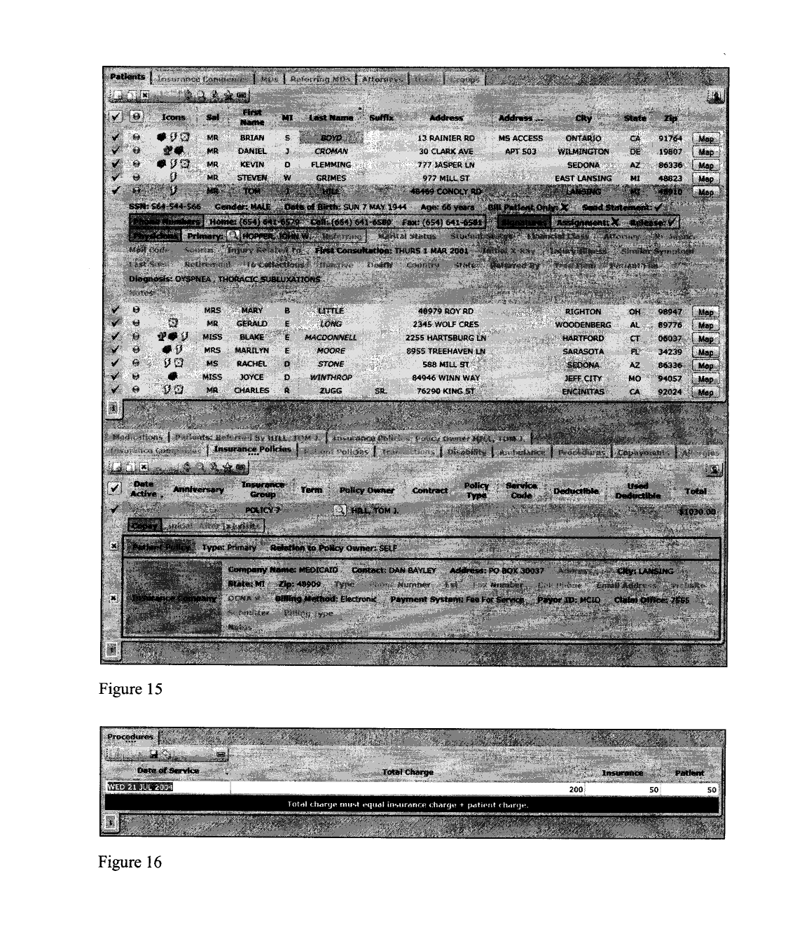

FIG. 15 shows an example of an M1 relationship, where the Patient Policy table is the M1 child of the Patient table and the Insurance Policy table. The M-Table status indicator includes a button only when there are one or more participating M1 tables on the page and one or more M1 rows are missing from the primary row. The main purpose of the button is to provide a method for the user to add the missing M1 rows. Clicking on the M-Table status indicator button will display every missing M1 row in edit mode. If all missing M1 rows are displayed in edit mode then clicking on the M-Table status indicator button will hide all of these new rows. If only some of the missing M1 rows are displayed in edit mode then clicking on the M1 status button will display all the other missing M1 rows in edit mode.

M3 & M5 Tables

Each participating M3 & M5 table will have its own tab of which it is the primary table.

Order of Appearance:

The order in which the parts of a selected row are displayed is as follows:

1. The inline row of the tab's primary table
2. The drilldown row of the tab's primary table
3. S1 & S2 child rows of the primary table
4. Foreign rows+their S1 & S2 child rows
5. M1 rows+their S1 & S2 child rows

Within sections 3, 4 & 5 of the row, the tables appear in the order in which the developer added them to the application. S1 & S2 rows always appear immediately beneath their parent row. If a parent row has more than one S1 or S2 child rows, they all appear immediately beneath their parent row in the order in which the developer added them to the application.

Editing Multiple Records:

Any displayed row on the page (primary, Foreign, S1, S2 or M1) can be edited in conjunction with any other row on the page. S1 and S2 rows are always edited in conjunction with their parent row. The tables of only one page of any of the application's page frames can be edited at any time, unless new primary rows are being added to a table (see below). Regardless of how many rows are being edited, only one row will ever be selected at any time. The tab's child page frame always displays the child records of the selected parent row.

Adding New Primary Rows to a Table:

When new rows are added to a primary table, new rows can also be added to any primary tables participating in the tab's child page frame. This provision extends to all the descendant tables of the initial primary table. Relationship types S4, S6, S7 & S8 require this capacity in that each of these relationships requires one or more child record for each parent record. If the primary table is an S5, S6 or S7 table and the maximum number of allowed records already exist, the user is informed and no new record is added.

Saving Changes:

All the changes made in every open edit row on the page (and its descendant page frames in the case of new records) are saved together by clicking the save tool in the toolbar or pressing Ctrl+S. Before the changes are committed to the database the changes are validated and verified.

Validations and Verifications:

The developer may specify a validation and/or verification function for each field in the application. These functions are called when changes are saved. The naming conventions [table name]_[field name]_validate and [table name]_[field name]_verify are used for the names of these functions.

Field Message Area:

Validation/verification messages are displayed in an area immediately below an inline field and to the right of a drilldown field.

Each validation/verification function is passed the following five parameters:

| Parameter | | | |
|---|---|---|---|
| # | Name | Data Type | Description/Notes |
| 1 | Current Field Value | Field | The current value of the field. |
| | | Data Type | |
| 2 | Original Field | Field | The original value of the field before the record |
| | Value | Data Type | was edited. |
| 3 | Current Row | Object | An object specifying the current values of each |
| | Values | | field in the table in the format {“field name”: “field |
| | | | value”, . . . } |
| 4 | Original Row | Object | An object specifying the original values of each |
| | Values | | field in the table in the format {“field name”: “field |
| | | | value”, . . . } |
| 5 | Foreign Table and | Object | An object specifying the display or current values |
| | S1, S2 Child Table | | of each field of every foreign parent table and |
| | Field Values | | every S1 and S2 table in the format {“table |
| | | | name”: {“field name”: “field value”, . . . }, . . . } |

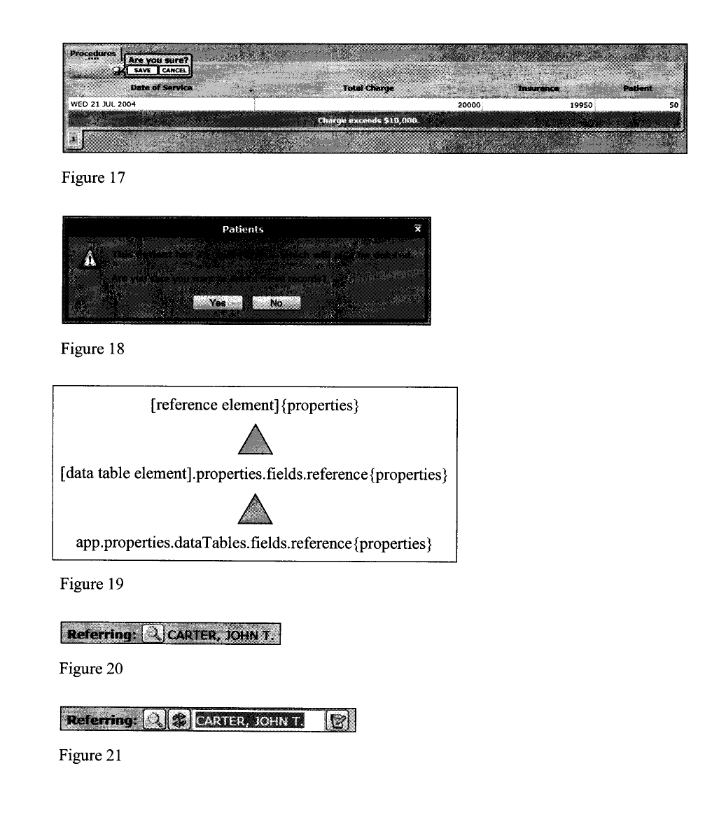

If the developer passes back a non-empty string from a validation/verification function, the text is displayed in the field message area, the field fails validation/verification and the record is not saved. If no validation/verification function exists for the field then it passes validation/verification. If a field fails validation, its value (or possibly the value of another field in the row) must be adjusted before the save will succeed. A field validation message is shown in FIG. 16. In the case of a verification message, as shown for example in FIG. 17, the user may choose to proceed with the save without changing the data or they may cancel the save and make changes first. Validations are displayed in a red block of the GUI while verifications are displayed in an orange block.

If the user attempts to save a new S4, S6, S7 or S8 parent record without also creating the required number of child records, a validation message is displayed and the save is cancelled. If the user is adding new S5, S6 or S7 records to an existing parent record, the database is checked to ensure the total number of child records will not exceed the allowed number; if it will, a validation message is displayed and the save is cancelled.

Deleting Records:

The developer may specify a row delete validation function for each table. The naming convention [table name]_row_validateDelete is used for the names of these functions.

Each delete validation function is passed the following four parameters:

| Parameter | | | |
|---|---|---|---|
| # | Name | Data Type | Description/Notes |
| 1 | Row Display | Object | An object specifying the display values of each |
| | Values | | field in the table in the format {“field name”: “field |
| | | | value”, . . . } |
| 2 | Foreign Table and | Object | An object specifying the display or current values |
| | S1, S2 Child Table | | of each field of every foreign parent table and |
| | Field Values | | every S1 and S2 table in the format {“table |
| | | | name”: {“field name”: “field value”, . . . }, . . . } |
| 3 | Count of Child | Number | Specifies the number of child records that will be |
| | Records to Delete | | deleted. Count does not include S1 or S2 tables. |
| 4 | Count by Table of | Object | An object specifying the number of records that will |
| | Child Records to | | be deleted from each child table in the format |
| | Delete | | {“table name”: count, . . . }. S1 and S2 tables are |
| | | | included in the count. |

If the developer passes back a non-empty string from a row validate delete function, the delete fails validation, the user is informed and the delete is cancelled.

If the delete passes validation and the number of non-S1/S2 child records is >0 (parameter 3), the user is informed of the number of child records they are about to delete and they must confirm the delete before it is executed. A delete verification message is shown in FIG. 18.

Reference Fields

In many cases, it is desirable to incorporate data from a foreign table within the child data table itself. A classic example is an order tracking database consisting of three data tables: “orders”, “order items” and “products”. In this database, “order items” has both “orders” and “products” as foreign tables. It makes sense to follow the description of paragraph entitled “S3-S8 Tables” and display the order items in the page frame following orders but if only the description of paragraph entitled “M1 & Foreign Tables” is followed for the product, then the product name would not be displayed until a row is selected. In this example, the interface would be much more user-friendly if the product name is a field in the inline row. In other scenarios, the foreign information is better suited to placement in the data table's drilldown row. The functionality of including information from one data table within the inline or drilldown row of another data table is provided by the reference field.

Nomenclature

A reference field is a field in the data table which displays a string representation of one or more fields from a foreign data table within the inline or drilldown row of the reference field's data table. A reference field can be any field in a data table other than the data table's primary key or one of its foreign keys.

The referenced fields of the reference field refers to the list of fields from the foreign, referenced data table.

The child data table of a referenced data table is the data table which contains the reference field.

Adding a Reference Field to the GUI

A reference field is appended to a data table by its .appendReference or .appendDrilldownReference function. The new reference field will be appended to the data table's inline or drilldown fields, respectively.

Specification

A reference field is specified by the following parameters:

| Parameter | | | Data | |
|---|---|---|---|---|
| # | Name | Required? | Type | Description/Notes |
| 1 | Physical | Yes | FNFDA | The name of the field in the database table. |
| | Field Name | | | |
| 2 | Field | Yes | String | The caption to display for the field. |
| | Caption | | Array of | |
| | | | Strings | |
| 3 | Referenced | Yes | String | The name of the referenced table. |
| | Table | | | |
| | Name | | | |
| 4 | Referenced | Yes | String | A list of field names from the referenced table |
| | Fields | | Array of | listed in the order they will be passed to the |
| | | | Strings | field's data-driven format function(s). An array |
| | | | | of strings is required if more than one field is |
| | | | | referenced; if only one field is referenced it can |
| | | | | be specified as a string. |
| 5 | Optional | No | Object | Overrides of inherited properties. |
| | Properties | | | |

Parameter Notes

Parameter 1—Physical Field Name:

FNFDA refers to a Field Name or Field Definition Array (FDA). A field name is specified by a string whereas a field definition array is specified by an array in the form [“field name”,“data type”,{options}] or [[“field name”,“old field name”],“data type”, {options}]. A field definition array is used when (re)building the database with some of the embodiments described herein. The first form of the array is used when creating a database table, adding a field to an existing database table or changing the data type of a field in an existing database table. The second form of the array is only used when renaming a field in an existing database table. The options available for the third parameter of the FDA are:

| | | Default | |
|---|---|---|---|
| Name | Data Type | Value | Description/Notes |
| allowNull | Boolean | true | The .allowNull setting specifies whether or not the field |
| | | | accepts NULL values. |
| drop | Boolean | false | If .drop is true, the field will be dropped from the table |
| | | | on the next database rebuild. |
| indexed | Boolean | false | If .indexed is true and the index doesn't already exist, |
| | | | an index will be built for the column on the next |
| | | | database rebuild. If .indexed is false and an index |
| | | | exists for the column, the index will be removed on the |
| | | | next database rebuild. |
| update | Boolean | false | If .update is true, an ALTER will be forced on the field |
| | | | on the next database rebuild. This is not normally |
| | | | necessary when changing a field's data type since |
| | | | various embodiments described herein will detect most |
| | | | data type changes. |

Parameter 2—Field Caption:

A string value or an array of two string values is required. If the specified value (or first parameter of an array) is non-string then the field name will be used as the caption. If the field name is desired as the field caption then undefined should be specified as the field caption. If there is no suitable caption for the field, then an empty string (“ ”) should be specified. The normal format of the field GUI is to display the field caption and then the field value or edit elements in the format Field Caption: [Field Value/Edit Elements]. If the field value and edit elements should be displayed within the field caption, then specify the location of the field value/edit elements with “[---]” as in “Field Caption Before [---] Field Caption After”.

The developer may choose to include a field in a grouped collection of fields in either the inline or drilldown portion of a row. An array of two strings should be specified for any field that is part of an inline or drilldown group. The first parameter of the array is used within the GUI of the display and edit rows while the second parameter is used everywhere else when referring to the field. For example, consider the field “hphone” which is part of a group named “Phone Numbers”. The proper field caption array for this field would be [“Home”,“Home Phone Number”].

Parameter 5—Optional Properties

The property inheritance model is illustrated in FIG. 19.

The default value of each property is the initial value set by various embodiments in app.properties.dataTables.fields.reference{properties}. The developer can override these default values and set new default values for every reference field in the entire application. Each data table in the GUI inherits .properties.fields.reference{properties} from app.properties.dataTables.fields.reference{properties}. The developer can override these inherited values and set new default values for every reference field appended to the specific data table. Each reference field in the GUI inherits .properties from its data table's .properties.fields.reference{properties}. The developer can override these inherited values for each individual reference field.

.type

| Data Type | Acceptable Values | Default Value |
|---|---|---|
| String | “quickpop”, “quickpick”, “poptable” | “quickpop” |

| Property Value | Description |
|---|---|
| “quickpop” | The input controls include both a quickpick and a poptable. |
| | A quickpick is another field type utilized in various embodiments. As |
| | the user types text into the quickpick's input element, a list of |
| | matching items in the database is displayed in a select element |
| | beneath the input element. The user can select an item from the |
| | select element using the mouse or the up and down keyboard |
| | buttons. The enter and tab keyboard buttons can be used to choose |
| | the selected item in the select element. |
| | A poptable is a button which when clicked displays the linked table |
| | in a new popup window. |
| “quickpick” | Only the quickpick input control is displayed. |
| “poptable” | Only the poptable input control is displayed. |

.ignoreCase:

Only applies to reference fields of type “quickpop” or type “quickpick”. This property specifies whether or not the search of existing items should respect the case of the user-entered text.

| Data Type | Acceptable Values | Default Value |
|---|---|---|
| Boolean | true, false | true |

.inputSize:

This property specifies the width (in number of characters to display) of the field's edit input.

| Data Type | Acceptable Values | Default Value |
|---|---|---|
| Integer | 5-50 | 10 |

.isRequired:

If the field's database column does not allow nulls then .isRequired is true, otherwise .isRequired is inherited. If .isRequired is true, the user will be forced to select a value before the record can be saved.

| Data Type | Acceptable Values | Default Value |
|---|---|---|
| Boolean | true, false | false |

.isSortable:

If .isSortable is true and the field is inline, the user can sort the data by clicking on the field's header cell. For both inline and drilldown fields, sortable columns are listed in the data table's sort dialog.

| Data Type | Acceptable Values | Default Value |
|---|---|---|
| Boolean | true, false | true |

.isUnique:

If .isUnique is true, the field value must be unique to the database table, within the current foreign ids (entire database table if the data table does not have foreign keys); the user will not be able to save the record if another record exists with the same value.

| Data Type | Acceptable Values | Default Value |
|---|---|---|
| Boolean | true, false | false |

Reference Field GUI

The reference field displays a string representing a row selected from another data table. The displayed string is calculated by passing the referenced fields from the referenced table to the field's data-driven format function(s).

When using a reference field with .type=“quickpop” or .type=“quickpick”, one or more data-driven format functions can be used with the field; when .type=“poptable” only one data-driven format function may be used.

When using only one data-driven format function, the naming convention [data table name]_[field name]_format must be used.

For multiple data-driven format functions, the functions must be consecutively numbered starting with 0 and following the naming convention [data table name]_[field name]_format[N].

Multiple data-driven format functions are used for enabling quickpick searches of the referenced table by different orders of the referenced fields; left-clicking on the change format button (FIG. 23) cycles through the formats while right-clicking on the button displays a context menu of all the formats.

When using multiple data-driven format functions, the displayed value of the field is calculated using the first (N=0) function. Table 1 lists examples of single and multiple data-driven format functions.

If no data-driven function exists for the field, the displayed value will be the referenced field values concatenated with a space.

Clicking the edit button (FIG. 24) of the reference field edit GUI will pop up the referenced table in a modal dialog. The user may change the referenced record by choosing a record in the modal dialog and pressing the Select button.

The modal dialog contains one page of a page frame without a tab. The tables participating in the modal dialog's page include the referenced table and any S1/S2/foreign table(s) to the referenced table. The modal dialog's page does not spawn a child page frame even if the referenced data table would normally spawn a child page frame.

All of the normal table functions including CRUD (create, update and delete) are available to the user for the table(s) in the popup modal dialog.

Reference fields of the tables in the modal dialog may themselves spawn additional modal dialogs. Each spawned modal dialog is organized into a separate layer of the GUI with no access to the layer beneath it. A translucent div element provides the physical boundary between layers enabling the user to see the data of lower levels put preventing access to that data until the modal dialog is closed.

If the developer does not specify a data-driven format function, various embodiments described herein will use a concatenation of the values of the referenced fields with a separator of a single space (“ ”).

An example of the reference display GUI is shown in FIG. 20.

An example of the reference edit GUI is shown in FIG. 21.

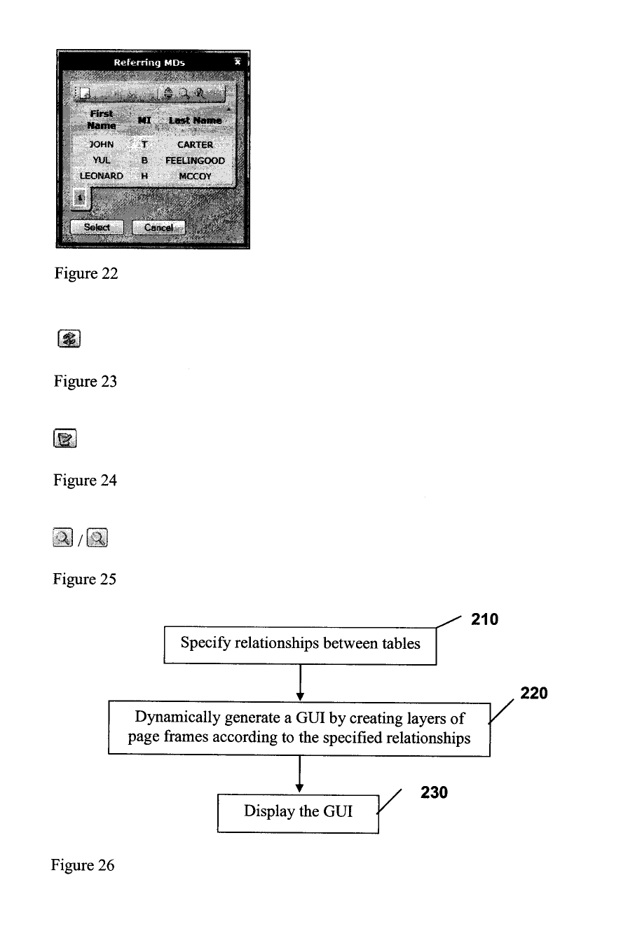

An example of the reference popup window is shown in FIG. 22.

Reference Field Data-Driven Format Function

The data-driven functions are developer-created functions which are named following precise naming conventions. The naming convention for the reference field's format data-driven function is [data table name]_[field name]_format or [data table name]_[field name]_format[N].

The parameters and return value of the format data-driven function are as follows:

Parameter

| # | Name | Data Type | Description/Notes |
|---|---|---|---|
| 1+ | Field Value | Field's | The value of the field. |
| | | Data Type | |

| Return Data Type | Description/Notes |
|---|---|
| String | The formatted value to display. |

### EXAMPLES

TABLE 1
EXAMPLES OF THE REFERENCE FIELD'S
DATA-DRIVEN FORMAT FUNCTION

| Table Name | Field Name | Reference Fields | Example |
|---|---|---|---|
| “patient” | “rdrmstid” | [“lname”, “fname”, “mi”] | [“Carter”, “John”, “T”] |

Single Data-Driven Format Function

| | |
|---|---|
| function patient_rdrmstid_format(s, t, u) | “Carter, John T.” |
| {return s + “,” + t + (u?“” + u + “.”: “”);} | |

Multiple Data-Driven Format Functions

| | |
|---|---|
| function patient_rdrmstid_format0(s, t, u) | “Carter, John T.” |
| {return s + “,” + t + (u?“” + u + “.”: “”);} | |
| function patient_rdrmstid_format1(s, t, u) | “John T. Carter” |
| {return t + “” + (u?u + “.”: “”) + s;} | |

Relational Effect of Reference Fields

Each reference field links a field of its data table to the primary key of a foreign table, establishing an S3 relationship from the referenced data table (parent) to the reference field's data table (child).

Referenced Record as a Foreign Table in the GUI:

When included as a foreign table of a page (as per the paragraph entitled “Foreign Tables”), the GUI of a referenced record follows the paragraph entitled “M1 & Foreign Tables” with the exception that the record is initially hidden from view. The display of the referenced record is toggled by clicking on the show/hide record toggle button (FIG. 25) of the related reference field. Any foreign records to the referenced record are initially displayed; their display can be toggled with their reference field's show/hide record toggle button. Alternate implementations here include (1) referenced records being initially displayed, (2) toggling the display of foreign records to the referenced record along with the referenced record and (3) both (1) and (2).

Page Frame Participation:

A referenced data table will participate in the page frame participation method of the paragraph entitled “Primary Tables” only if it does not appear in the relational pillar of its child data table. If the referenced data table does participate in the page frame participation method, the referenced data table is treated as an uncommitted relational parent in the method of the paragraph entitled “Primary Tables”.

Relational Pillars:

A relational pillar is a group of interrelated data tables in an application. Each application will have one or more relational pillars. The following steps are used to calculate the relational pillars of an application:
1. Collect a list of relational trees of data tables which do not have any child tables.
2. Combine any items with intersecting relational trees.
3. Each item (group of tables) in the list is a relational pillar of the application.

Clone-Spawning Reference Fields:

If a referenced data table appears within its child table's relational pillar then a clone of the relational pillar will be created. The fourth step in the method of the paragraph entitled “Relational Pillars” is to (1) set a flag for each reference field in the data tables of each relational pillar indicating whether or not it is a clone-spawning reference field and (2) set a pointer to its relational pillar.

Inclusion of Non-Clone-Spawning Reference Fields in the Relational Pillars:

The fifth step in the method of the paragraph entitled “Relational Pillars” is to add the relational tree of the referenced table of any non-clone-spawning reference field to its relational pillar. When a relational pillar is cloned, the non-clone spawning reference fields in the cloned relational pillar will reference a table in the cloned relational pillar.

Clone-Linking Relationship:

The sole link between a relational pillar and its clone is an S3 relationship between the reference field's referenced data table and the clone of the reference field's data table from the primary key of the referenced data table to the reference field in the clone of the reference field's data table.

Self-Referenced Reference Fields:

A self-referenced reference field is a reference field which specifies its own data table as its referenced data table. A self-referenced reference field is always a clone-spawning reference field.

Clone Naming:

Each data table in the clone of the relational pillar is assigned a unique table name in the application.

The new name is a concatenation of the original name and an iterative counter. If another data table exists in the application with the same name as the new name then the counter is incremented and the process repeated until a unique name is found.

Tab Caption:

In order to uniquely identify the clone of the reference field's data table to the user, the caption of the cloned data table's page frame tab follows the naming convention “[data table caption]: [reference field caption] [reference field's formatted display value]”. For example, in an “employee” data table (caption “Employees”) containing the self-referenced reference field “reportsTo” (caption “Reports To”), the page frame tab caption of the clone of the employee data table is “Employees: Reports To” [reference field's formatted display value]. The “Employees: Reports To” part of the caption is static while the reference field's formatted display value will differ for each record in the original “employee” data table. If the referenced fields parameter (parameter 4) of the reference field is [“salutation”,“firstName”,“lastName”] with field values [“Dr.”,“Leonard”,“McCoy”], respectively in the original “employee” data table, then the page frame tab caption for the clone of “employee” data table will be “Employees: Reports To Dr. Leonard McCoy” for that referenced record. Note that for this example since no data-driven format function is specified, the reference field's formatted display value is simply a space-delimited concatenation of the values of the referenced fields.

Timing of Clone Creation:

When the application is launched, the only data table that is cloned is the reference field's data table. Clones of all the other data tables in the relational pillar are made only if (1) the user clicks on the page frame tab of the clone of the reference field's data table or (2) if the clone of the reference field's data table is the first or only primary data table in its page frame, then the copies are made when the user selects a record in the reference field's referenced data table.

Delaying the bulk of the data table cloning serves to speed up application launch following just-in-time programming practices and also prevents what would otherwise be a race condition with endless propagation of clones of relational pillars.

Clones' Foreign Keys:

Once the cloned table has been assigned a new name, its foreign tables are scanned and each foreign table's name (pointer) is replaced with the name of the foreign table's clone in the cloned relational pillar. The reference fields of the data table are then scanned and the names of the referenced tables are likewise replaced with the name of the referenced table's clone in the cloned relational pillar.

The cloned data tables are processed in the order in which the developer added them to the application to ensure that a cloned data table will always be renamed before any relational pointers to itself are encountered in the method of the paragraph entitled “Clones' Foreign Keys”.

The method of the paragraph entitled “Clones' Foreign Keys” does not include the clone-linking relationship established in the paragraph entitled “Clone-Linking Relationship”. The reference field in the clone of the reference field's data table retains this pointer to the referenced data table in the original relational pillar.

Multiple layers of cloned relational pillars are possible with the number of clones limited only by how deeply the user navigates the GUI following the steps outlined in the paragraph entitled “Timing of Clone Creation”.

Clone-Linked Boundary:

The single S3 relationship established between the reference field's referenced data table and the clone of the reference field's data table by the clone-spawning reference field is the only relationship between these two data tables. This relationship serves as a boundary (clone-linked boundary) between the original relational pillar and its clone.

In the GUI, the clone-linked boundary separates the original relational pillar from its clone. The data tables of the cloned relational pillar only participate in the page frame participation method of the paragraph entitled “Page Frame Participation Method” in descendant page frames of the reference field's referenced data table.

When some embodiments described herein create SQL statements to retrieve the various data for a page of a page frame involving the cloned relational pillar, the clone-linked boundary is never crossed with the single exception of the one S3 relationship between the original clone-linking data table and the clone of the clone-linking data table. In other words, any foreign ids that have been set by selecting records in the data tables of the original relational pillar do not apply to the SQL statements created for the data tables of the cloned relational pillar with the exception of the foreign id from the clone-spawning reference field in the original clone-linking data table to the primary key of the cloned clone-linking data table.

The S3 relationship between the reference field's referenced data table and the clone of the reference field's data table serves as a link between a relational pillar and its clone. For the first clone, the link is to the group of original data tables. For the second clone, the link is between the second and first clones of the relational pillar (not to the original relational pillar).

Reference is now made to FIG. 26, which is a flowchart diagram illustrating the basic method performed by system 100 of FIG. 1. At 210, relationships are specified between tables. In various embodiments, the relationships are specified by a developer. In various embodiments, a relationship between at least two tables is specified.

At 220, a graphical user interface is dynamically generated by creating layers of page frames according to the specified relationships.

At 230, the GUI is displayed. In various embodiments, the GUI is displayed on monitor 130 of system 100.

It should be understood that in various embodiments, the creation of the graphical user interface is dynamic. Accordingly, as relationships are specified the GUI is updated displayed dynamically.

The above-described embodiments are intended to be examples only. Those of skill in the art can effect alterations, modifications and variations without departing from the scope.

Although this disclosure has described and illustrated certain embodiments, it is also to be understood that the system, apparatus and method described is not restricted to these particular embodiments. Rather, it is understood that all embodiments which are functional or mechanical equivalents of the specific embodiments and features that have been described and illustrated herein are included.

It will be understood that, although various features have been described with respect to one or another of the embodiments, the various features and embodiments may be combined or used in conjunction with other features and embodiments as described and illustrated herein.

What is claimed is:

1-11. (canceled)

12. A computer implemented user interface for a relational database, the relational database containing data tables comprising records, the user interface comprising:
one or more page frames each being configured to display a plurality of pages of the each page frame on a display directed by a processor, each page of the plurality of pages corresponding to a table in the relational database and having a plurality of participating tables related to the corresponding table according to relationships of tables in the relational database, each of the one or more page frames comprising:
a table selection section, the table selection section comprising a plurality of table selectors, each table selector corresponding to a respective page of the plurality of pages of the each page frame, selection of which designates the respective page as an active page and the corresponding table as an active table;
a table data section for providing access to and displaying records of the active table, the records being organized for displaying in one or more display pages;
selection of a record of the active table displayed in the table data section of a page frame causing construction and display of a new page frame by the processor in addition to the display of the active table, the new page frame being a child page frame of the active page for displaying one or more child tables identified from the tables of the relational database and the page frame being a parent page frame of the child page frame, the one or more child tables being identified iteratively for inclusion in the child page frame by the processor and being all tables related to the active table of the parent page frame according to relationships specified in the relational database, the table selectors of the child page frame corresponding to a group of tables consisting of all the one or more child tables identified for inclusion; and
a page selection section, the page selection section comprising one or more page selectors each corresponding to a respective display page of the one or more display pages, selecting a page selector of the one or more page selectors causing the processor to direct the display of the corresponding respective display page.

13. The computer implemented user interface of claim 12, wherein the table data section includes an inline data portion for displaying inline data and a drilldown data portion for displaying drilldown data.

14. The computer implemented user interface of claim 12, wherein the plurality of participating tables of a page includes a primary table corresponding to the active table and a list of supplemental tables, each of the supplemental tables being related to the primary table according to a user specified subset of relationships of the relationships of tables in the relational database.

15. The computer implemented user interface of claim 14, wherein the table data section includes an inline data portion for displaying inline data of the primary table and a drilldown data portion for displaying optional drilldown data of the primary table and data of the supplemental tables.

16. The computer implemented user interface of claim 12, wherein the child page frame is displayed upon selection of a record from the active table in the parent page frame of the child page frame.

17. The computer implemented user interface of claim 12, wherein the one or more child tables identified for inclusion in the child page frame by the processor include ancestor tables of the active table and child tables of any one of the ancestor tables according to relationships specified in the relational database.

18. The computer implemented user interface of claim 17, wherein a table active in one or more ancestor page frames of the child page frame is excluded from the ancestor tables for inclusion in the child page frame.

19. The computer implemented user interface of claim 12, wherein selection of record displayed in a child page frame iteratively causes the processor to display one other new page frame, the one other new page frame being a child page frame at a lower level of the child page frame displaying the selected record, child tables included to participate in the one other new page frame of the lower level being related to the active tables of the child page frame displaying the selected record and all active tables of all parent page frames at higher levels according to relationships specified in the relational database.

20. The computer implemented user interface of claim 19, wherein at least one of the relationships is a parent-child relationship between a parent table and a child table and the child table in the parent-child relationship is included for participation in the child page frame at a level immediately below the level of the page frame in which the parent table in the parent-child relationship participates.

21. The computer implemented user interface of claim 20, wherein the one or more child tables included in the child page frame of a page frame are immediate child tables of the tables in the page frame, each of the included child table having at least one parent data table in its relation tree participating in at least one of the parent pages.

22. The computer implemented user interface according to claim 12, wherein each child page frame includes at least one active child table accessible from the each child page frame.

23. The computer implemented user interface according of claim 22, further comprising a filter to selectively exclude a subset of records of the at least one active child table from being displayed in the child page frame.

24. The computer implemented user interface according of claim 12, further comprising a filter to selectively exclude a subset of the child tables from the child page frame.

25. The computer implemented user interface according of claim 24, further comprising a filter selector, actuating said filter selector allowing user access to and modification of the subset of excluded child tables.

26. The computer implemented user interface of claim 12, wherein tables corresponding to pages of a topmost page frame that is not a child page frame are selected from the group consisting of:
(a) all data tables of the relational database,
(b) all data tables of the relational database that have no parent tables,
(c) a user specified collection of data tables of the relational database, and
(d) a combination thereof.

27. The computer implemented user interface of claim 12, wherein the one or more page selectors comprise at least a single page selector and at least a page range selector, selecting a single page selector causing a corresponding display page to be displayed and selecting a page range selector causing multiple page selectors to be displayed for a user to select display pages in a corresponding page range.

28. The computer implemented user interface of claim 12, wherein selecting a page selector retrieves data to be displayed in the corresponding page and displays the retrieved data in a corresponding display page of the corresponding page.

29. The computer implemented user interface of claim 12, wherein selecting a page selector corresponding to the currently displayed display page causes retrieval of displayed data and refreshing of the currently displayed display page.

30. The computer implemented user interface of claim 13, wherein the inline data portion is partitioned into a plurality of rows for displaying inline data of records of the active table.

31. The computer implemented user interface of claim 30, wherein selection of any row of the plurality of rows enables editing of any data fields in the selected row.

32. The computer implemented user interface of claim 30, wherein the data table section is configured for adding a new row, addition of the new row also adding a new record to the active table and a corresponding new record to all child tables of one or more user-specified relationship types in the child page frames of the active table.

33. The computer implemented user interface of claim 30, further comprising a verification message window, said verification window being displayed and confirmation input required from a user prior to deleting, saving or changing records of the active table and any of its child tales in the child page frames.

34. The computer implemented user interface of claim 30, wherein the table data section initially displays the inline data portion, selecting a row in the displayed inline data portion causing the drilldown data portion to be displayed and any associated drilldown data to be displayed in the displayed drilldown data portion.

35. The computer implemented user interface of claim 12, further comprising a toolbar section, the toolbar section including tool selectors for selecting pre-defined tool functions.

36. The computer implemented user interface of claim 35, wherein the tool selectors includes a drilldown display selector, actuating the drilldown display selector causes the drilldown data section to alternate between a display mode and a non-displayed mode.

37. The computer implemented user interface of claim 35, wherein the pre-defined tool functions includes at least one of creating new records, copying existing records, editing selected records, saving changes, cancelling changes and deleting selected records.

38. The computer implemented user interface of claim 12, wherein one of a pre-selected key actuation, actuation of an edit selector defined in the toolbar section and a combination thereof causes the table data section to switch between an edit mode and a display mode.

39. The computer implemented user interface of claim 12, the data table section further comprising a reference field portion, the reference field portion including at least a reference field for displaying a representation of one or more fields from a foreign table, the reference field portion including tool selectors for selecting pre-defined tool functions.

40. The computer implemented user interface of claim 39, wherein the reference field portion is placed within the inline data portion.

41. The computer implemented user interface of claim 39, wherein the reference field section is placed within the drilldown data portion.

42. The computer implemented user interface of claim 39, wherein the tool selectors include a dialog selector, selection of the dialog selector causing a dialog window to appear to display therein the foreign table.

43. The computer implemented user interface of claim 42, wherein the dialog selector is an edit selector.

44. The computer implemented user interface of claim 42, the dialog window includes additional tables selected according to relationships between the foreign table and other tables in the relational database.

45. The computer implemented user interface of claim 44, wherein selection of a dialog selector within one of the additional tables in the dialog window iteratively causes the processor to display a new dialog window and to display therein the one additional data table.

46. The computer implemented user interface of claim 45, wherein the new dialog window includes more additional data tables selected according to relationships between the one additional data table and data tables in the relational database.

47. A system for creating a computer implemented user interface for a relational database, the relational database containing data tables comprising records, the system comprising:
a display for presenting the computer implemented user interface to a user, and
a processor configured to generate the computer implemented user interface according to claim 12, to display the computer implemented user interface on the display, and to update dynamically the computer implemented user interface upon receiving user input from the computer implemented user interface.

48. A computer implemented method for creating a computer implemented user interface for a relational database, the relational database containing data tables comprising records, the method comprising:
retrieving data from a storage device to obtain information pertaining to identifying a plurality of participating tables according to relationships of tables in the relational database,
generating the computer implemented user interface according to claim 12,
displaying the computer implemented user interface on a display, and
dynamically updating the computer implemented user interface upon receiving user input from the computer implemented user interface.

49. A computer readable non-transitory storage medium containing computer program instructions stored thereon for creating a computer implemented user interface for a relational database, the relational database containing data tables comprising records, the computer program instructions, when executed by a processor, causing the processor to:
retrieve data from a storage device to obtain information pertaining to identifying a plurality of participating tables according to relationships of tables in the relational database,
generate the computer implemented user interface according to claim 12,
display the computer implemented user interface on a display, and
dynamically update the computer implemented user interface upon receiving user input from the computer implemented user interface.
